(19) United States
(12) Patent Application Publication
(10) Pub. No.: US 2004/0113793 A1
(43) Pub. Date: Jun. 17, 2004

(54) Tracker

(76) Inventor: Marian Virginia Braxton, Sterling, VA (US)

Correspondence Address: Marian Virginia Braxton, 47526 Coldspring Place, Sterling, VA, 20165, US

(21) Appl. No.: 10/247,770

(22) Filed: Dec. 16, 2002

(51) Int. Cl. G08B 23/00

(52) U.S. Cl. 340/573.1

(57) ABSTRACT

The tracker device can be used to provide entity (person, pet, etc.) wearing the device an automatic means of signaling authorities in cases of emergencies/danger.

The tracker device will automatically activate with a rise in body temperature or elevated stress levels.

The tracker will emit a unique signal to alert authorities of the particular entity (individual, pet, etc.) that is associated with that unique tracker device.

The tracker device will be capable of emitting a scent or dye that can only be removed by authority or physicians using a special solution (solution to be determined).

Each tracker will be assigned a unique identifiable number (UIN) upon issuance that will be maintained in a tracker database provided to local, state, medical, federal, and national public safety agencies and recognized authorized security companies.

### BACKGROUND OF THE INVENTION

Due to the number of persons kidnaped every year I felt the best thing to do is to prevent people from being kidnaped or make it possible for the victim to get immediate help by setting off the tracking device alerting authorities to the attack while it is taking place. Also the tracking device would have a mechanism to give off a scent or a dye that would lead the authorities to the attackers in the cases where the attackers had fled the attack scene. The device is hidden inside a bracelet, necklace, locket, key chain, ring, watch, earrings, pet collar or any type ornament which would have direct contact with the victim's skin so that the victim could easily activate the device to signal for help if able, or the adrenaline from the body would activate the device and transmit a signal back to the police or private security company.

The owner of pets could activate or have the authorized personnel activate the device which could be hidden inside the pet's collar and the signal would lead the owner, police or security authority to the missing animal.

### BRIEF SUMMARY OF THE INVENTION

The device could be a microchip or some other signaling device hidden inside a specially designed bracelet, locket, ring, watch, collar, etc. The dye or scent alarm could also be purchased as part of a package with the tracker.

If individuals purchased and wore the device, especially when jogging, or in areas where they could be in danger this would prevent a lot of people being abducted and if they were abducted the chances of interrupting the crimes would be greater, plus the authorities would have a better chance of catching the guilty persons because of the scent gas or visible dye which has now been sprayed on the abductors.

### BRIEF DESCRIPTION OF THE SEVERAL VIEWS OF THE DRAWING

FIG. 1A shows the “TRACKER” EMBEDDED IN A WRIST WATCH

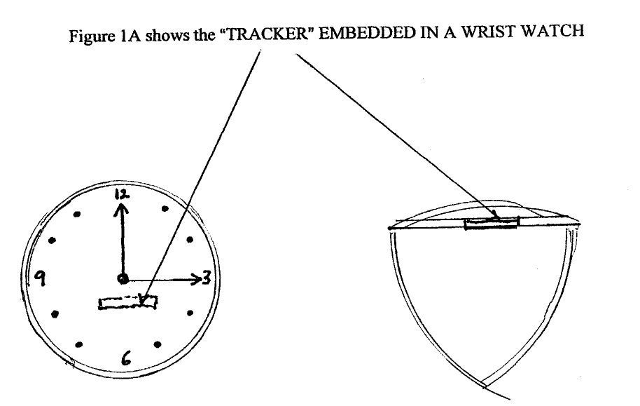

### DETAILED DESCRIPTION OF THE INVENTION

The TRACKER is a device that emits a non-audible signal and a visible dye that helps track victims in danger.

1. The tracker device is unique in that it is activated by rises in body temperature and or a stress sensing activator.
In this regard, it differs from simple “homing” devices.
